(19) United States
(12) Patent Application Publication
(10) Pub. No.: US 2003/0229156 A1
(43) Pub. Date: Dec. 11, 2003

(54) Fingerprint ink composition

(76) Inventor: Ronald Stanley, Hawthorne, CA (US)

Correspondence Address: LAW OFFICES OF ADAM H. JACOBS, PATENT ATTORNEY, SUITE 726, 1904 FARNAM STREET, OMAHA, NE, 68102, US

(21) Appl. No.: 10/455,912

(22) Filed: Jun. 6, 2003

Related U.S. Application Data
(60) Provisional application No. 60/387,042, filed on Jun. 6, 2002.

(51) Int. Cl. C03C 17/00; C09D 5/00

(52) U.S. Cl. 523/160; 523/161

(57) ABSTRACT

A dye-based fingerprint ink composition includes a fatty-acid based dye dispersed in a chemical composition which includes approximately equal parts of (a) 2 phenoxyethanol, (b) propylene glycol, (c) a carrier and (d) glyceryl monoricinoleate. The composition further includes a viscosity adjustment chemical selected from the polyvinyl family of chemicals, the viscosity adjustment chemical operative to add accuracy to said dye-based fingerprint ink formulation and provide improved ridgeline definition. The fatty-acid based dye comprises less than approximately two percent (2%), by weight, of the fingerprint ink composition yet still provides acceptable quality and contrast levels.

### CROSS-REFERENCE TO RELATED PROVISIONAL APPLICATION

This application claims priority to the filing date of related provisional patent application serial No. 60/387,042 and a filing date of Jun. 6, 2002.

### BACKGROUND OF THE INVENTION

1. Technical Field

The present invention is directed to fingerprinting ink compositions used for creation of fingerprints for identification purposes and, more particularly, to a non-staining, easily removable fingerprinting ink composition consisting of a dye, a non-volatile oil, a plurality of solvents and additional chemicals for increased viscosity and enhanced skin removability.

2. Description of the Prior Art

Fingerprints have been used for many years to provide a method for the positive identification of individuals. For many years, fingerprints were obtained by dispensing a viscous ink onto a plate, the person to be fingerprinted rolling his or her fingers in the ink, then transferring the inked fingers to a piece of paper where the finger was rolled on the paper to transfer the fingerprint to the paper. Of course, this system had its inherent drawbacks, such as excessive staining of the skin and, due to the viscous nature of the ink, a somewhat slippery consistency which often resulted in smudged images of the fingerprint.

To improve the fingerprinting system of the prior art, and to permit the use of fingerprinting systems in retail and banking industries, for example, there have been developed numerous types of fingerprinting inks and fingerprinting systems which attempt to alleviate the disadvantages described previously. Critical features of such inks are that the fingerprinting ink must be non-staining on the skin so that customers are not required to clean up after using the fingerprinting ink and, further, that the ink must have a formulation which may be packaged for a period of time without separation of the ingredients thereof yet still function correctly. Also, it is desirable for the ink to possess sufficient opacity and neutrality of color for reproduction on microfilm and microfiche, as many documents are commonly disposed of after they have been recorded on film.

Fingerprinting inks which do not leave a visible residue on the fingertips have been available in the prior art for some time. However, such inks generally require the use of two separate chemical compounds, one being applied to the fingerprint area and the other transferred to the fingerprint-retaining surface after the fingerprinting procedure is performed to form a visible reaction product which shows the fingerprint. For obvious reasons, such a two-step process is both time-consuming and expands the potential for errors made during the fingerprinting process. There is therefore a need for a fingerprinting ink formulation which does not require the two-step process found in the prior art.

Therefore, in the prior art, there appear non-pigmented inks which do not stain the fingertips but do not provide ideal color and accuracy and pigmented inks utilizing a carbon pigment which will stain the fingers and require clean-up. There is therefore a need for a fingerprinting ink that provides the necessary accuracy to determine an individual's identity and which is also easily removable from the individual's skin, and further that can be quickly and easily used by individuals being fingerprinted.

Therefore, an object of the present invention is to provide an improved fingerprint ink composition.

Another object of the present invention is to provide an improved fingerprint ink composition which is non-staining and easily removable.

Another object of the present invention is to provide an improved fingerprint ink composition consisting of a dye, a non-volatile oil, a plurality of solvents and additional chemicals for increased viscosity and enhanced skin removability.

Another object of the present invention is to provide an improved fingerprint ink composition which can be used in a variety of applicator systems and may be quickly and easily substituted for inks of the prior art to provide improved fingerprinting capabilities.

Another object of the present invention is to provide an improved fingerprint ink composition which is usable in fingerprinting pads currently being manufactured.

Finally, an object of the present invention is to provide a fingerprint ink composition which is relatively simple and inexpensive to compose and is safe, efficient and easily removable in use.

### SUMMARY OF THE INVENTION

The present invention provides a fingerprint ink composition which includes a low structure fatty-acid based dye dispersion having a fatty-acid based dye dispersed in a chemical composition. The chemical composition includes approximately equal parts of (a) 2 phenoxyethanol, (b) propylene glycol, (c) a carrier selected from the group consisting of nonvolatile oils, nonvolatile oil complexes, fatty alcohols and fatty acid esters and (d) glyceryl monoricinoleate. The chemical composition for the ink further includes a viscosity adjustment chemical selected from the group consisting of the polyvinyl family of chemicals, preferably polyvinylpyrrolidone K90, the viscosity adjustment chemical operative to add accuracy to the dye-based fingerprint ink formulation and provide improved ridgeline definition. Importantly, the fatty-acid based dye comprises less than approximately two percent (2%), by weight, of the low structure fatty-acid based dye dispersion such that the low structure fatty-acid based dye dispersion, namely the dye-based fingerprint ink formulation, provides acceptable quality and contrast levels.

It is thus seen that the present invention provides a substantial improvement over those inventions found in the prior art. For example, the fingerprint ink of the present invention permits the user to create accurate copies of the fingerprints and then quickly and easily remove the ink from his or her finger pad by merely wiping the finger pad with a cloth or paper towel or the like. Furthermore, as the present invention is relatively simple in composition and uses materials which are reasonably readily available, it is far more cost-effective to produce than those fingerprinting inks found in the prior art. Finally, because the fingerprint ink formulation of the present invention is usable with presently available ink pads, it may be easily substituted for currently available fingerprinting inks without requiring modification of the ink pads. The present invention thus provides a substantial improvement over the prior art.

### DESCRIPTION OF THE PREFERRED EMBODIMENT

The non-staining fingerprinting ink formulation of the present invention is a less than two percent (2%) dye-based ink formulation which, in the preferred embodiment, would include equal parts of three solvent chemicals, specifically 2 phenoxyethanol, propylene glycol and a non-volatile oil (fatty acid ester), such as oleic acid. These solvents are combined with a base chemical such as glyceryl monoricinoleate, commonly sold under the name of Flexricin 13, in a 1 to 1 ratio with each of the solvent chemicals such that each of the four described additives are substantially equal in amount. This chemical assists in making the ink formulation of the present invention wipe off the skin easier in addition to binding the ink formulation together. These four chemicals together provide the basis for the ink formulation of the present invention, with the remaining ingredients providing the coloration and adjusting the viscosity of the formulation to permit proper functioning of the ink formulation in the reception and transference of fingerprints to a recording medium.

The preferred dye chemical used with the ink formation of the present invention is a free-flowing blackish-blue powder from the chemical family of azine hue, a family of fatty acid-based dye solutions. Specifically, the present invention contemplates the usage of Spectra Nigrosine, namely, Spectra Colors 8SL0007D, at a ratio of approximately 47 grams of dye to each gallon of the ink formulation being produced. The Spectra Nigrosine base dye is selected for use with the present invention as it offers good light fastness, strength, shade, and solubility for making the fingerprinting ink composition of the present invention, and it is to be further noted that the addition of more of the dye to the formulation of the present invention would result in a darker version of this particular ink which is contemplated by this disclosure.

For viscosity, approximately 70 grams of polyvinylpyrrolidone K90 per each gallon of the ink formulation being produced is added to the fingerprint ink formulation of the present invention. It has been found that the K90 provides better ridgeline definition to the fingerprint transfer which adds accuracy to the ink and thus aids in the identification process. Furthermore, the addition of such a polymer will minimize the degree to which the graphics, i.e. the fingerprint, can become blurred, lose contrast, and degrade the resolution.

Finally, approximately one point two grams (1.2 g) of 2 SL00031 Chrysoidine and one-half gram (0.5 g) of Violet 7SL00080 is added to the previously-described ink formulation components. In the preferred embodiment, the Chrysoidine acts to enhance the Spectra Nigrosine base dye and provide additional color depth to the ink formulation to increase the contrast of the ink formulation to the recording media such as paper which is used to receive the fingerprint. An important feature of the ink formulation of the present invention is that the pigment amount is less than two percent (2%) yet still provides acceptable contrast levels with high quality for identification purposes. This ink therefore solves two of the main problems encountered in the formulation of fingerprinting inks, first that the pigment amount is low enough to ensure easy removability from the skin following completion of the fingerprinting process and second that the high contrast level is maintained even with the lower pigment percentage. The inventor is unaware of any other fingerprinting ink formulation in the prior art which solves both of these problems, and therefore believes himself to have invented a novel fingerprinting ink formulation which is superior in many respects to those inks found in the prior art.

It is then preferred that the ink formulation of the present invention be impregnated into a fingerprinting pad constructed of any of a number of acceptable materials. Acceptable construction materials would include but not be limited to paper, chip board, 5 to 10 micron porous plastic or ceramic plates having a porosity range of approximately forty-eight to fifty-eight percent (48% to 58%). These fingerprinting pad materials are then placed within a container and the user of the pad would merely open the container, press the finger to be printed on the pad transferring a quantity of ink to the fingertip pad, press the fingertip onto a recording medium such as paper to record the fingerprint, then wipe the ink from the fingertip leaving little if any ink residue.

Of course, it is to be noted that variations in the amounts of the ingredients used for the present invention are to be expected, although these variations are expected to be less than approximately two percent (2%) variance. However, it is preferred that the ink formulation ingredients described herein be combined in approximately the same amounts as described to ensure proper functioning of the ink formulation. Furthermore, substitutions of various types of equivalent chemicals may be made to the present invention without deviating from the intended broad scope of the present description and the appended claims.

There has therefore been shown and described a novel fingerprint ink composition which accomplishes all of its intended objectives.

I claim:

1. A dye-based fingerprint ink formulation comprising: a low structure fatty-acid based dye dispersion including a fatty-acid based dye dispersed in a chemical composition including:
approximately equal parts of (a) 2 phenoxyethanol, (b) propylene glycol, (c) a carrier selected from the group consisting of nonvolatile oils, nonvolatile oil complexes, fatty alcohols and fatty acid esters, (d) glyceryl monoricinoleate;
a viscosity adjustment chemical selected from the group consisting of the polyvinyl family of chemicals, said viscosity adjustment chemical operative to add accuracy to said dye-based fingerprint ink formulation and provide improved ridgeline definition; and
said fatty-acid based dye comprising less than approximately two percent (2%), by weight, of said low structure fatty-acid based dye dispersion such that said low structure fatty-acid based dye dispersion provides acceptable quality and contrast levels.

2. The dye-based fingerprint ink formulation of claim 1 wherein said viscosity adjustment chemical is polyvinylpyrrolidone K90.

3. A dye-based fingerprint ink formulation comprising:
a low structure fatty-acid based dye dispersion including a fatty-acid based dye dispersed in a chemical composition including:
approximately equal parts of at least two chemicals selected from the group consisting of (a) 2 phenoxyethanol, (b) propylene glycol, (c) a carrier selected from the group consisting of nonvolatile oils, nonvolatile oil complexes, fatty alcohols and fatty acid esters, and (d) glyceryl monoricinoleate;
a viscosity adjustment chemical selected from the group consisting of the polyvinyl family of chemicals, said viscosity adjustment chemical operative to add accuracy to said dye-based fingerprint ink formulation and provide improved ridgeline definition; and
said fatty-acid based dye comprising less than approximately two percent (2%), by weight, of said low structure fatty-acid based dye dispersion such that said low structure fatty-acid based dye dispersion provides acceptable quality and contrast levels.

4. A dye-based fingerprint ink formulation comprising:
a low structure fatty-acid based dye dispersion including a fatty-acid based dye dispersed in a chemical composition including:
approximately equal parts of (a) 2 phenoxyethanol, (b) propylene glycol, (c) a carrier selected from the group consisting of nonvolatile oils, nonvolatile oil complexes, fatty alcohols and fatty acid esters, (d) glyceryl monoricinoleate;
a viscosity adjustment chemical selected from the group consisting of the polyvinyl family of chemicals, said viscosity adjustment chemical operative to add accuracy to said dye-based fingerprint ink formulation and provide improved ridgeline definition; and
said fatty-acid based dye comprising less than approximately ten percent (10%), by weight, of said low structure fatty-acid based dye dispersion such that said low structure fatty-acid based dye dispersion provides acceptable quality and contrast levels.

5. The dye-based fingerprint ink formulation of claim 4 wherein said fatty-acid based dye comprises less than approximately five percent (5%), by weight, of said low structure fatty-acid based dye dispersion.

6. The dye-based fingerprint ink formulation of claim 4 wherein said fatty-acid based dye comprises less than approximately two percent (2%), by weight, of said low structure fatty-acid based dye dispersion.
